(19) United States
(12) Patent Application Publication
(10) Pub. No.: US 2009/0213597 A1
(43) Pub. Date: Aug. 27, 2009

(54) LED CANDELABRA FIXTURE AND LAMP

(76) Inventor: Allan R. NELKIN, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/392,597

(22) Filed: Feb. 25, 2009

Related U.S. Application Data
(60) Provisional application No. 61/031,944, filed on Feb. 27, 2008.

(51) Int. Cl. F21V 21/00

(52) U.S. Cl. 362/392

(57) ABSTRACT

An electric lighting lamp or bulb having an LED light source mounted to a candle base, and wherein driver circuitry for the LED light source is housed within the candle base. A transparent globe encloses the LED light source, and the lamp presents the appearance of a traditional candle and/or of an incandescent candelabra or chandelier-type lamp or bulb.

### CROSS-REFERENCE TO RELATED APPLICATION

This application claims the benefit of U.S. Provisional Patent Application Ser. No. 61/031,944, filed Feb. 27, 2008, the entirety of which is hereby incorporated herein by reference for all purposes.

### TECHNICAL FIELD

The present invention relates generally to electric lighting, and more particularly to an LED candelabra or chandelier-type lamp or lightbulb, and a fixture for receiving one or more such lamps.

### BACKGROUND OF THE INVENTION

Traditional incandescent lamps or lightbulbs have been found to suffer from a variety of shortcomings, including inefficient use of energy and limited lifespan. Other types of lamps, such as compact fluorescent lamps (CFLs) and light emitting diode (LED) lighting are taking the place of incandescent lamps in certain applications. These newer forms of lighting, however, often present their own challenges. For example, challenges related to LED lighting applications include the dissipation of heat, and the space requirements of electronic driver circuitry for LED lights.

Thus it can be seen that needs exist for continuing improvements to lighting components, fixtures and systems. It is to the provision of an improved lamp, and to lighting fixtures, systems and methods related thereto, meeting these and other needs that the present invention is primarily directed.

### SUMMARY OF THE INVENTION

In example forms, the present invention is an LED lamp for use in connection with candelabra and/or chandelier type lighting fixtures. In one aspect, the lamp of the present invention includes an LED light source, a candle base housing the electronic driver circuitry for the LED light source, and a transparent globe affixed to the candle base and surrounding the LED light source.

In another aspect, the invention is chandelier or candelabra light fixture comprising one or more sockets for receiving an LED lamp as described above.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows an LED candelabra-type lamp or bulb, and a portion of a fixture for receiving such a lamp or bulb, according to example forms of the present invention.

FIG. 2 shows a chandelier-type lighting fixture incorporating a plurality of LED candelabra lamps according to another example form of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

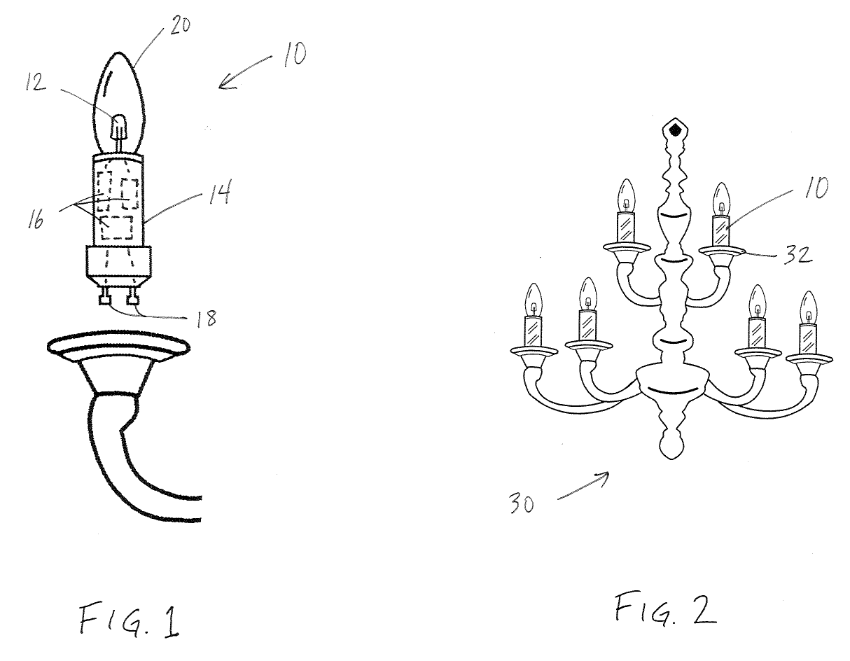

With reference now to the drawing figures, FIG. 1 shows an LED lamp or bulb 10 according to an example form of the present invention. The lamp 10 includes a light emitting diode (LED) light source 12. The LED 12 may take the form of any of a variety of LEDs of various wattage and/or light output color. The lamp 10 further comprises a candle base 14, housing internal driver circuitry components 16 for powering the LED 12. The candle base 14 further includes two or more electronic contacts 18 extending from its lower end for delivering electricity to the driver circuitry components 16. A transparent globe 20 of glass, plastic, or other material preferably surrounds the LED 12, and is affixed at an upper end of the candle base 14. The candle base 14 is preferably generally cylindrical, having a diameter and a height of at least one to two times the diameter, and has a white, cream, beige, or other exterior color; and the transparent globe 20 is preferably tapered to a point at its distal end, whereby the lamp 10 generally presents the appearance of a candle and/or of a traditional incandescent candelabra or chandelier-type lamp.

In example forms, the candle base 14 of the lamp 10 comprises a small electrical contact base, comprising the contacts 18 and having a size and shape compatible with any of various standard lighting fixture connections, such as E12, GU10, Ba15 contact configurations. As seen in FIG. 2, one or more lamps 10 according to the present invention may be used in connection with a light fixture 30, such as a chandelier, wall sconce, post light, outdoor lantern or the like, which commonly utilize candelabra or chandelier-type lamps having the appearance of traditional candles. In example forms, the candle base 14 sits in a cup 32 that is part of the fixture 30, or alternatively may be part of the lamp 10. The candle base 14 and/or the cup 32 of the fixture optionally comprise one or more fins or heat sink members formed of metal or other heat-transmissive materials, to assist in dissipating heat from the LED 12 and/or from the driver circuitry components 16.

The invention further includes a light fixture 30 for receiving and delivering energy to one or more lamps 10 as described. The fixture includes at least one socket configured to receive the candle base 14 of the lamp(s). In the depicted embodiment, the fixture is a multi-lamp, hanging chandelier type of fixture, but the invention also includes fixtures including wall-mounted, floor or table-standing lamp, hanging, single or multi-bulb, sconce, pendant, and other fixture types. The at least one socket of the fixture preferably includes two or more electronic terminals or contacts for delivering electrical energy to corresponding contacts of the lamp(s). Optionally, the LED driver circuitry components are housed in the fixture, rather than the lamp bases. The fixture preferably further comprises one or more wires or other conduits for delivering electricity from a remote source to the lamps, and optionally comprises a switch, sensor or other control means for turning the light on and off, and/or for adjusting the intensity of the light delivered. The fixture optionally also may include one or more diffusers or shades for assisting in distributing or focusing the light output.

While the invention has been described with reference to preferred and example embodiments, it will be understood by those skilled in the art that a variety of modifications, additions and deletions are within the scope of the invention, as defined by the following claims.

What is claimed is:

1. An electric lighting lamp comprising:
a candle base;
driver circuitry housed within the candle base; and
an LED light source mounted to the candle base and in electrical connection with the driver circuitry.

2. The electric lighting lamp of claim 1, further comprising a transparent globe surrounding the LED light source.

3. The electric lighting lamp of claim 1, wherein the candle base comprises a standard format contact base having at least two electrical contacts.

4. The electric lighting lamp of claim 1, further comprising at least one heat dissipation member.

5. The electric lighting lamp of claim 1, wherein the candle base has a diameter and a height, and wherein the height is at least 1½ times the diameter.

6. A lighting fixture comprising a base, at least one lamp coupling, and at least one electrical conductor for delivering electricity from an external source to the at least one lamp coupling; wherein the at least one lamp coupling is adapted to receive an electric lighting lamp comprising a candle base, an LED light source mounted to the candle base, and electronic driver circuitry for the LED light source housed within the candle base.

7. The lighting fixture of claim 6, wherein the at least one lamp coupling comprises a cup-shaped member.
